(19) United States
(12) Patent Application Publication
(10) Pub. No.: US 2005/0065633 A1
(43) Pub. Date: Mar. 24, 2005

(54) Systems and methods for relative control of load motion actuators

(76) Inventors: Michael Wynblatt, Moraga, CA (US); Hartmut Ludwig, West Windsor, NJ (US); Lingyun Wang, Plainsboro, NJ (US)

Correspondence Address: Attn: Elsa Keller, Legal Administrator;Siemens Corporation, Intellectual Property Department, 170 Wood Avenue South, Iselin, NJ, 08830, US

(21) Appl. No.: 10/886,897

(22) Filed: Jul. 7, 2004

Related U.S. Application Data
(63) Continuation-in-part of application No. 10/845,337, filed on May 12, 2004.
(60) Provisional application No. 60/520,519, filed on Nov. 14, 2003.
(60) Provisional application No. 60/479,037, filed on Jun. 17, 2003.

(51) Int. Cl. G06F 7/00

(52) U.S. Cl. 700/213

(57) ABSTRACT

Systems, methods and computer program code for the relative control of load motion actuators in load processing systems are provided which may include selecting actuator control strategies to move loads in accordance with desired explicit and/or relative load behaviors.

### CROSS-REFERENCE TO RELATED APPLICATIONS

This application claims priority and benefit as a continuation-in-part under 35 U.S.C. § 120 to U.S. patent application Ser. No. 10/845,337, entitled “Systems and Methods for Controlling Load Motion Actuators”, filed in the name of Wynblatt et al. on May 12, 2004, and priority and benefit under 35 U.S.C. § 119(e) to U.S. Provisional Patent Application Ser. No. 60/520,519, entitled “A Method for Mapping Load Motion Vectors to Control Commands for a Matrix of Actuators”, filed in the name of Wynblatt et al. on Nov. 14, 2003, the contents of both which are hereby incorporated by reference in their entirety for all purposes.

### BACKGROUND

The present disclosure relates generally to the control of load motion actuators and, more particularly, to the mapping of explicit and/or relative load motion vectors to control commands for a matrix of actuators.

Load processing systems such as those used in warehouses, package distribution plants, assembly plants, and manufacturing plants are often utilized to move loads from one location to another. These loads are often moved using load motion actuators such as conveyor belts, rollers, robotic arms, or pin-hole air jets.

An example of a load processing system 100 is shown in FIG. 1. The system 100 may comprise, for example, multiple loads 102a-c such as load 102a which may be moved from position A to position B by a group or matrix of actuators 104. For example, the load processing system 100 may be a set of conveyor belts 104 that are used to convey manufacturing parts from a storage location (position A) to an assembly location (position B) within an assembly line of a factory or other manufacturing facility.

The movements of the loads 102a-c may be described in terms of translational and rotational displacement. For example, a two-dimensional coordinate system having an x-axis 106 and a y-axis 108 may be used to track, locate, or otherwise identify or describe the location of the loads 102a-c. Any difference in the coordinate position of a given load 102a over time may thus be calculated or represented as a translational displacement (in terms of movement with respect to the axes 106, 108 for example). The rotational displacements of the loads 102a-c may be determined with reference to a centerline, axis, or other reference line 110 of the loads 102a-c. For example, the angular relation of the centerline 110 of load 102a with respect to one or more of the axes 106, 108 may be noted over time to determine a change in the rotational orientation of the load 102a.

Currently, load processing systems must typically be programmed to move a load from one position to another. For example, the load motion actuators must typically be controlled by programming specific speeds and directions for each actuator in the load processing system. The programmed actuators may then transport a load from one location to another by applying the programmed speeds and directions at pre-programmed times and for pre-programmed durations.

This requires the programmer to be highly skilled in selecting speeds and directions for all of the various actuators in a given load processing system, and requires many programming hours to configure the system to properly transport a given load. Where multiple loads are transported by the same system, the required speeds and directions of the actuators become increasingly complex for the programmer to determine, and require substantially more programming hours to configure. In situations where one load is desired to be transported relative to another load, the programming of the actuators becomes even more complex and time consuming.

Accordingly, there is a need for systems and methods for controlling load motion actuators, and particularly for relative control of load motion actuators, that address these and other problems found in existing technologies.

### SUMMARY

Methods, systems, and computer program code are therefore presented for relative control of load motion actuators in load processing systems.

According to some embodiments, systems, methods, and computer code are operable to determine a desired relative behavior for a first load with respect to a second load, the loads being moveable by a plurality of load actuators. In some embodiments, the plurality of load actuators may be arranged in a substantially planar matrix. According to some embodiments, systems, methods, and computer code may be further operable to select a strategy for controlling the plurality of load actuators based at least in part on a score associated with the strategy. In some embodiments, a plurality of strategies for controlling the plurality of load actuators may be scored.

According to some embodiments, systems, methods, and computer code are operable to predict a first behavior of a first load that would result from implementation of a strategy, predict a second behavior of a second load that would result from implementation of the strategy, determine a first difference between the first behavior and a desired behavior of the first load, determine a second difference between the second behavior and a desired relative behavior of the second load with respect to the first load, and sum the first and second differences.

According to some embodiments, systems may include means for scoring a plurality of strategies for controlling a plurality of load actuators, wherein the scoring is based at least in part on a relative behavior for a first load with respect to a second load, and means for selecting a strategy from the plurality of strategies based at least in part on the score associated with the strategy.

With these and other advantages and features of embodiments that will become hereinafter apparent, embodiments may be more clearly understood by reference to the following detailed description, the appended claims and the drawings attached herein.

### BRIEF DESCRIPTION OF THE DRAWINGS

FIG. 1 is a block diagram of a system for processing loads;

FIG. 2 is a flowchart of a method according to some embodiments;

FIG. 3 is a block diagram of example actuator control strategies according to some embodiments FIG. 4 is a block diagram of a system for processing loads according to some embodiments;

FIG. 5 is a graphical diagram of a system for processing loads according to some embodiments;

FIG. 6 is a flowchart of a method according to some embodiments;

FIG. 7 is a flowchart of a method according to some embodiments;

FIG. 8 is a flowchart of a method according to some embodiments;

FIG. 9 is a flowchart of a method according to some embodiments;

FIG. 10 is a block diagram of a system according to some embodiments;

FIG. 11 is a flowchart of a method according to some embodiments; and

FIG. 12 is a block diagram of a system according to some embodiments.

### DETAILED DESCRIPTION OF SPECIFIC EMBODIMENTS

Some embodiments described herein are associated with an “actuator”, “load actuator”, or “load motion actuator”. As used herein, the terms “actuator”, “load actuator”, and “load motion actuator” may be used interchangeably and may generally refer to any devices and/or systems capable of causing, directing, controlling, and/or otherwise contributing to the movement of an object. Examples of actuators may include, but are not limited to, rollers, conveyor belts, pin-hole air jets, motors, servos, cables, valves, magnets, and/or various robotic devices such as arms, gates, cranes, and hydraulic lifts. In some embodiments, an actuator may be or include an electronic device or component such as a processor, a printed circuit board (PCB), and/or any other type of electrical connection and/or circuit associated with the movement of an object.

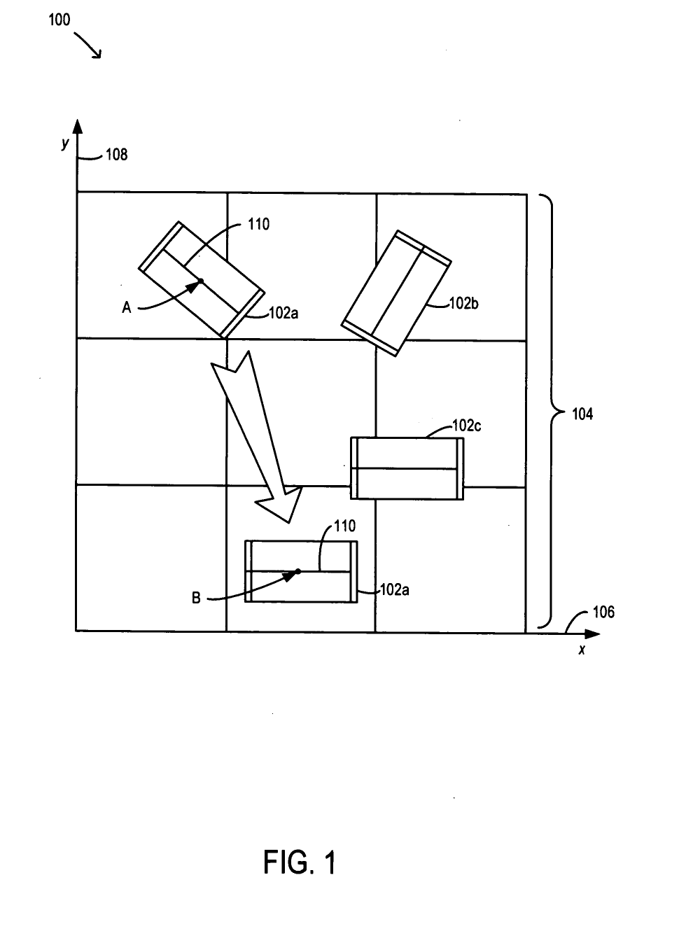

Some embodiments described herein are associated with a “matrix”, “set”, “plurality”, or “group” of actuators. As used herein, the terms “matrix”, “set”, “plurality”, and “group” may be used interchangeably and generally refer to one or more actuators within a load processing system. In some embodiments, a matrix of actuators may include a plurality of actuators that are interrelated and/or uniform. For example, as shown in FIG. 1, a grid of multiple adjacent actuators may form a substantially planar surface for moving a load. According to some embodiments, the actions of one actuator of a group of actuators may effect and/or determine an action of one or more other actuators of the group. Groups of actuators may include actuators of a single type and/or configuration or may include multiple and/or varying types and/or configurations of actuators. For example, a matrix of actuators may include both conveyor belts and rollers arranged in a particular manner to effectuate the movement of a load.

Some embodiments described herein are associated with an “overlap” or an “overlap area” associated with an actuator. As used herein, the term “overlap” may generally refer to the condition where a load and/or a portion of a load is located within and/or on an area capable of being effected by a particular actuator. As used for illustrative purposes herein, for example, a load may overlap a conveyor belt actuator when a portion of the load is located on a portion of the conveyor belt. In other words, a conveyor belt is capable of moving a load when any portion of the load is in contact with the conveyor's belt surface. As used herein, the term “overlap area” may generally refer to the contact area between a load and an actuator and/or an actuator's area of influence. With pin-hole air jet actuators, for example, the overlap area may be defined as the surface area of the load that may be acted upon by the jet of air from the actuator (i.e., the portion of the load within the air jet's area of influence).

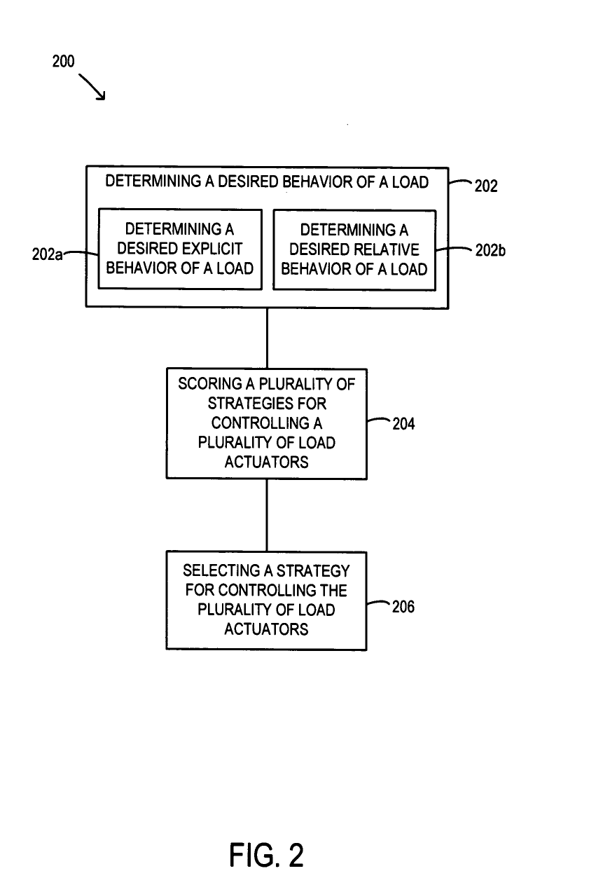

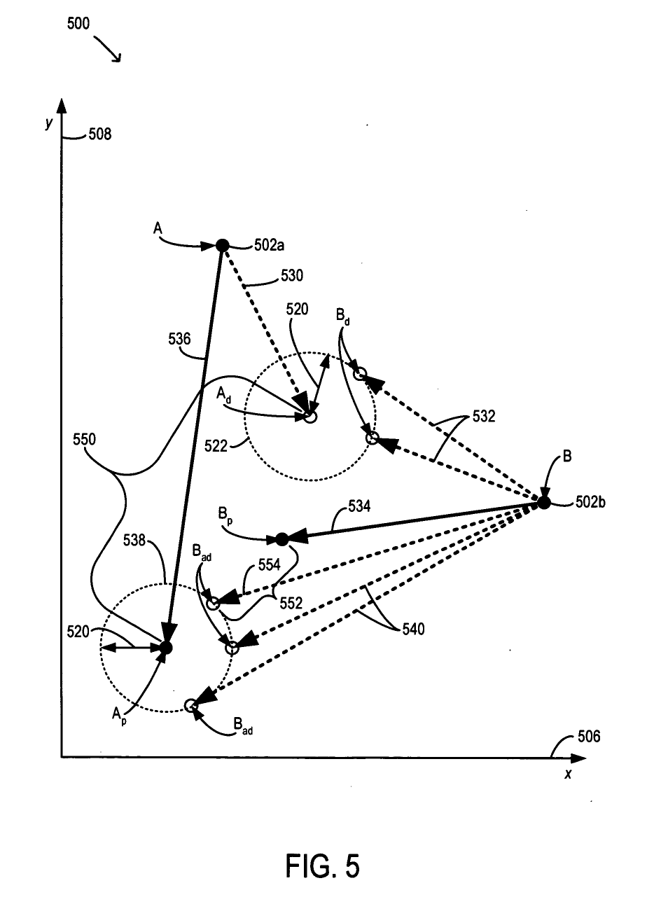

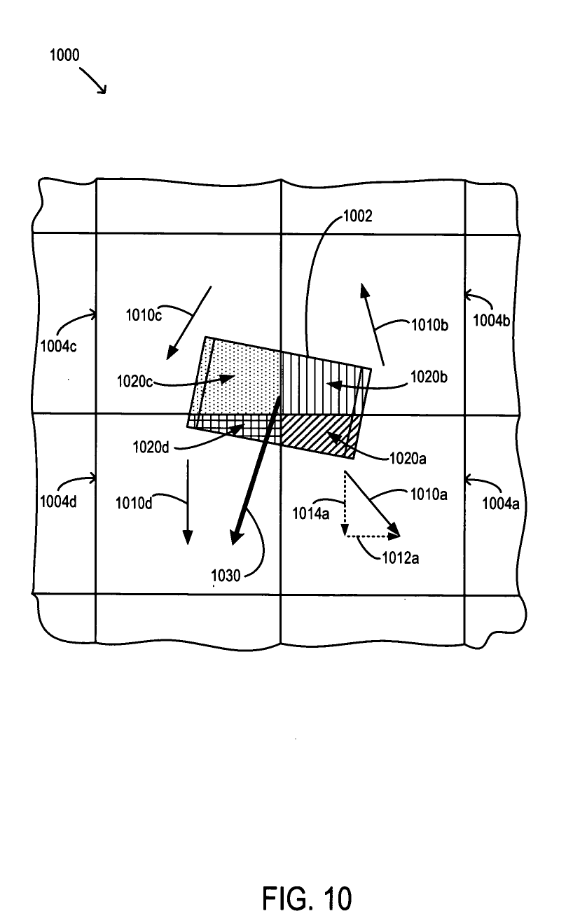

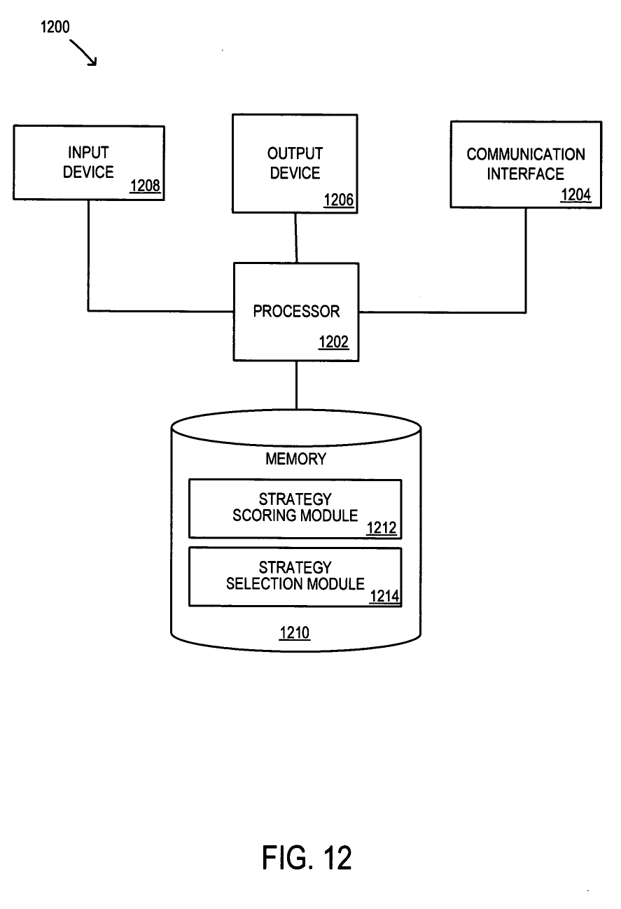

Referring to FIG. 2, a flow diagram of a method 200 for controlling actuators in accordance with some embodiments is shown. The method 200 may be associated with and/or performed by, for example, any of the systems 100, 400, 500, 1000, and/or 1200 (or one or more of the system components) described in conjunction with FIG. 1, FIG. 4, FIG. 5, FIG. 10, and FIG. 12, respectfully herein. The flow diagrams described herein do not necessarily imply a fixed order to the actions, and embodiments may be performed in any order that is practicable. Note that any of the methods described herein may be performed by hardware, software (including microcode), firmware, or any combination thereof. For example, a storage medium may store thereon instructions that when executed by a machine result in performance according to any of the embodiments described herein.

In some embodiments (such as shown in FIG. 2), the method 200 may begin by determining a desired behavior of a load, at 202. For example, the load may be moveable by a plurality of actuators, and a programmer or other entity may desire that the actuators be controlled to move a load from a first location to a second location. In some embodiments, a user may enter a desired load motion into a computer and/or other interface. The user may specify, for example, that the load is desired to move from point A to point B (such as points A and B of FIG. 1) and that the load is to rotate thirty degrees with respect to a specific axis.

In some embodiments, these types of behaviors may be referred to as “explicit” behaviors. The method 200 may include, for example, determining a desired explicit behavior of a load, at 202a. The user may specify, for example, one or more specific behaviors and/or actions that the load is desired to undertake and/or achieve. According to some embodiments, the explicit behavior may be independent of other loads and/or parameters. In specifying that the load is to move from point A to point B, for example, the user may be supplying all the information that is necessary to appropriately move the load.

According to some embodiments, the method 200 may also or alternatively include determining a desired “relative” behavior of a load, at 202b. Relative behaviors may, for example, be or include behaviors that depend upon other loads and/or parameters. In some embodiments, the user may specify a relative behavior for a load with respect to another load. For example, the user may specify that one load is to stay five centimeters from another load. Such a request may, according to some embodiments, be satisfied when the location and/or velocity of the other load is known, predicted, and/or otherwise determinable.

In some embodiments, one or more explicit and/or relative behaviors may be determined (e.g., at 202a and/or 202b) for a load. In systems that include multiple loads, one or more explicit and/or relative behaviors may be determined for each and/or every load in the system. For example, it may be determined that a load is desired to travel at a velocity of one foot per second (e.g., an explicit behavior) while maintaining a separating distance of three inches from the nearest neighboring load (e.g., a relative behavior). In some embodiments, the combination of both an explicit and a relative behavior for a load may be called a “hybrid” behavior.

According to some embodiments, the desired load behavior (such as an explicit and/or relative behavior) may be determined based upon one or more characteristics of the load. For example, the type of load may be associated with a particular destination. In other words, the desired behavior of moving the load from a first location to the associated destination may be determined based upon the type of load. For example, a manufacturing part such as a vehicle windshield may need to be moved to a particular assembly station where windshields are installed. The part may be marked, tagged, or otherwise identifiable as a windshield, and the intended destination/behavior may thus be determinable from the load itself.

As another example, a load determined to be a particular type of package may be associated with a particular type of packing machine. It may be known, for example, that loads of this particular type should enter the packing machine at certain orientations and/or with certain separating distances between the loads entering the machine (e.g., the machine may require certain package spacing to function properly). In other embodiments, the characteristic of a load may not need to be determined and/or may not be indicative of a desired behavior of a load.

Other characteristics of a load may also be indicative of and/or otherwise associated with one or more intended behaviors. In some embodiments for example, the load type may dictate translational and/or rotational speed and/or acceleration limits within which the load may safely be transported. According to some embodiments, the load type may also or alternatively dictate minimum, maximum, and/or desired separating distances between various loads and/or load types. The desired behavior of a load may therefore be express, implied, user-defined, inherent to a particular load or load type, and/or any combination thereof.

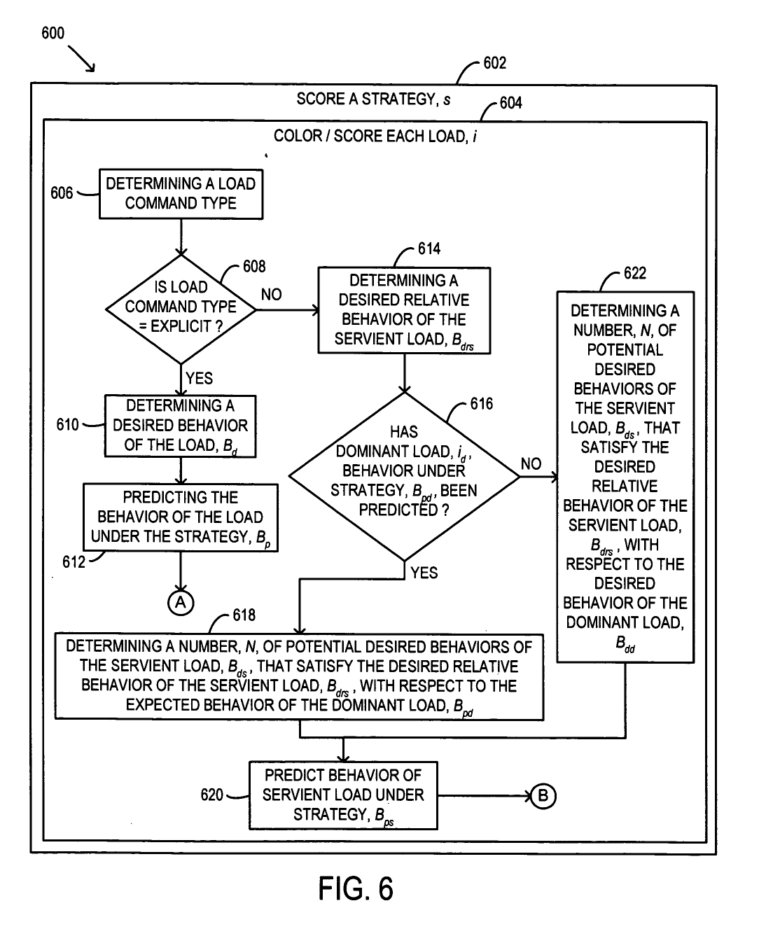

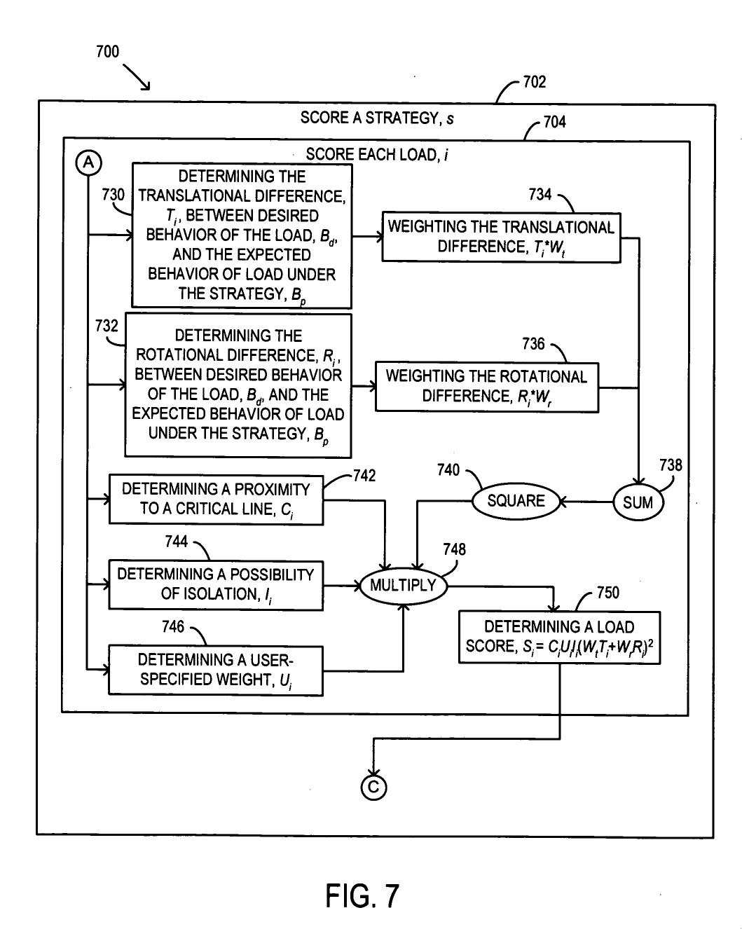

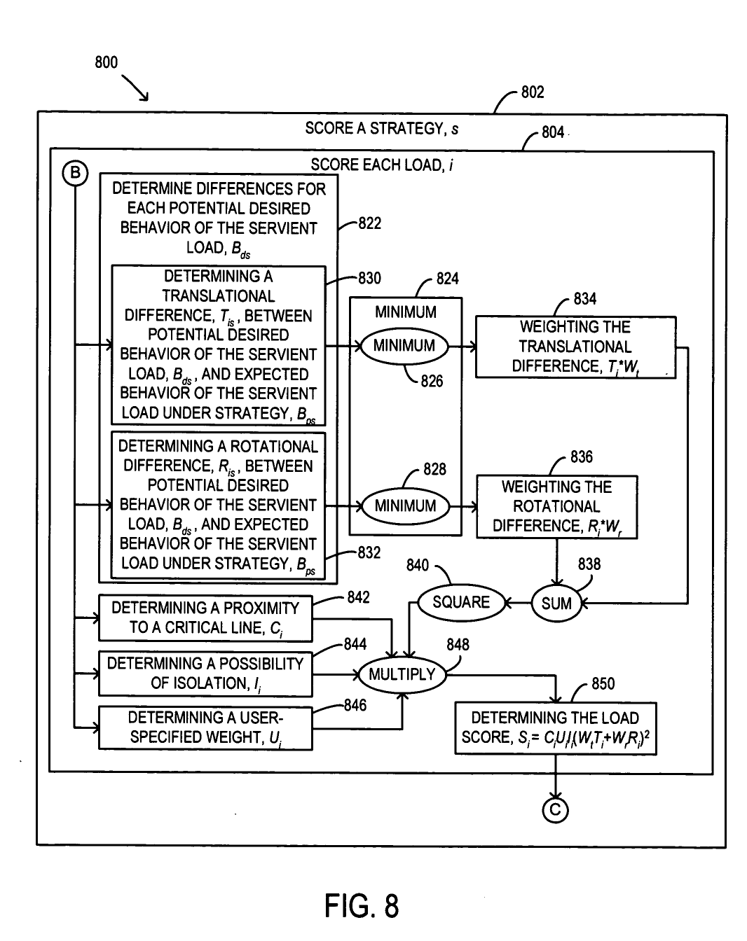

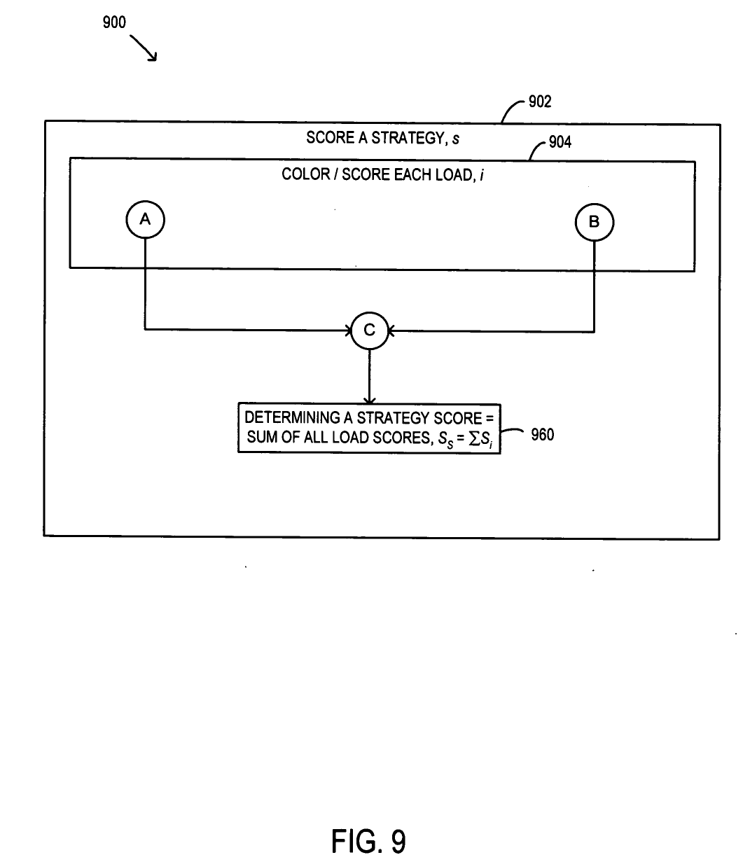

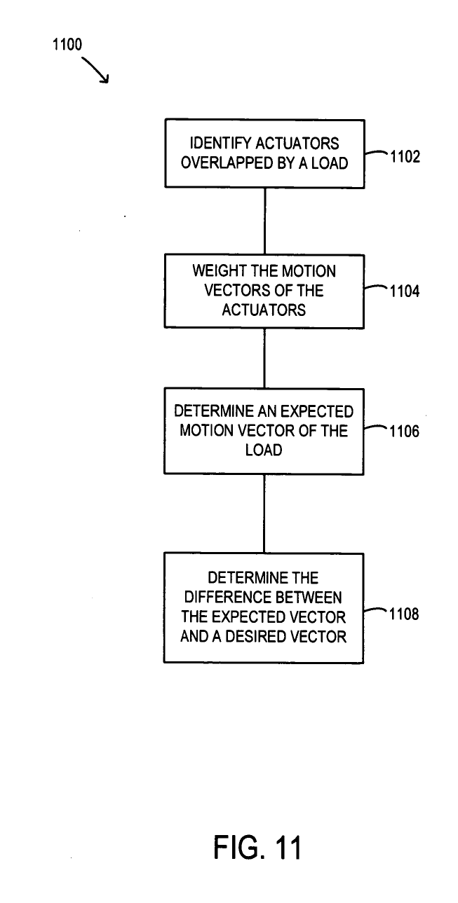

In some embodiments, the method 200 may continue at 204 by scoring a plurality of strategies for controlling the plurality of load actuators. The scoring at 204 may be conducted, for example, in accordance with any of the methods 600, 700, 800, 900, and/or 1100 described in conjunction with FIG. 6, FIG. 7, FIG. 8, FIG. 9, and FIG. 11, respectively herein. According to some embodiments, the plurality of load actuators controlled by the strategies may be or include a matrix of actuators.

There may be many possible ways to control one or more actuators to cause a load to undertake a particular behavior. The combination of actuator commands, settings, and/or controls for a plurality of actuators may be referred to as a “strategy”. Strategies may be scored based upon any criteria that is or becomes known. In some embodiments, a strategy may be scored based upon how close the strategy would come to moving an object in the manner desired (e.g., the score may represent a likelihood of success). Where a single load or object is desired to be moved, for example, any strategy that is capable of moving the object to the desired position may score very well. In the simple case of a single object, a variety of strategies may be capable of achieving the desired results (i.e., all of the strategies may have a similar likelihood of success). In some embodiments (such as the single object case), each of the strategies may be scored on other factors instead of or in addition to likelihood of success.

For example, while many strategies may be capable of moving an object from one point to another, some strategies may accomplish the task in a small amount of time, while others may take considerably longer. In some embodiments, the strategies may be scored, for example, at least partially based upon how quickly the strategy may result in successfully moving the object. According to some embodiments, strategies may be scored based upon whether the strategy would cause a load to be moved, rotated, and/or accelerated within the limits acceptable for the particular object. In some embodiments, strategies may be scored using a combination of scoring criteria (how successful, how quickly, within acceptable limits, etc.).

Where more than one object is desired to be moved (such as with loads 102a-c in FIG. 1), strategies may vary significantly in expected performance. In some embodiments, no strategy that is or becomes known may be capable of achieving the exact desired behavior. In some embodiments, strategies may be scored, for example, based upon how close they come to achieving the desired behavior. According to some embodiments, each strategy may be expected to cause each load to have an expected translational and/or rotational deviation from their desired behaviors. The score of a strategy may, for example, be or include (or otherwise take into account) either or both of these expected deviations. In some embodiments, one or more expected deviations may be determined (such as in methods 700, 800, 1100, for example). According to some embodiments, the expected deviations for each load in the load processing system may be summed to determine a total expected deviation for a given strategy (e.g., as is method 900).

Examples of other factors that may be included in and/or affect a strategy's score may include, but are not limited to, load size, load priority, user-defined parameters, actuator and/or load limitations, and/or various relationships between two or more loads (e.g., certain types of loads may need to be maintained at certain minimum separation distances, etc.). Strategies may be scored in any practicable method and/or manner that is or becomes known. In some scoring schemes, for example, low scores may be associated with better performing strategies, while in other scoring schemes, higher scores may indicate more desirable performance.

According to some embodiments, the plurality of strategies may be analyzed to determine expected load behaviors under each of the plurality of strategies. In some embodiments, predicting expected load behavior under a strategy may be called a “coloring”. Loads to be transported and/or otherwise processed may, for example, be “colored” to determine how the loads may behave if a given strategy is implemented. In some embodiments, coloring may be performed prior to and/or as part of the scoring of the strategies (e.g., at 204).

In some embodiments, the method 200 may continue at 206 by selecting a strategy for controlling the plurality of load actuators. According to some embodiments, the strategy may be selected based at least in part on a score associated with the strategy. The score associated with the strategy may be or include, for example, the score determined at 204. In some embodiments however, the score may not be determined by method 200. In other words, the scoring of strategies at 204 may be optional, and may not occur in some embodiments. For example, the scores associated with the strategies may be pre-determined and/or determined by a separate entity, device, and/or system. For ease of explanation, it will be assumed that the strategies are scored at 204 as described herein.

According to some embodiments, the strategy with the best score may be selected. For example, the strategies may be scored based directly upon expected deviations for the desired load behavior. The lowest numeric score may therefore correspond to the strategy that would result in the smallest deviation. In some embodiments, this lowest-scoring strategy may be selected. According to some embodiments, other factors, scores, and/or variables may also or alternatively be considered in the selection of a strategy. For example, some loads (such as perishable loads, for example) may have a higher priority than others. The priority of loads may therefore be included in the scoring of the strategies (as described above) and/or may be considered as a separate factor in addition to strategy scores.

In some embodiments, one or more actuator control strategies may be selected, compiled, and/or otherwise determined in method 200. For example, the strategies to be scored at 204 may be determined by selecting desirable strategies from a database and/or lookup table of available strategies. According to some embodiments, one or more strategies may be created in method 200. Based on information regarding the performance of known and/or scored strategies, for example, one or more new strategies may be created. In some embodiments, the new strategy may be designed to decrease the amount, magnitude, and/or type of deviation expected between the new strategy and desired load behaviors.

According to some embodiments, any selected actuator control strategy (such as the one selected at 206) may be applied and/or assigned to the matrix of load actuators. For example, the strategy with the best score may be selected and each (or any) of the load actuators may be controlled in accordance with the selected strategy. In some embodiments for example, the actuators may be set to certain speeds and/or directions as defined by the chosen strategy. The movement of loads may then be tracked to monitor the effectiveness of the strategy. In some embodiments, method 200 may be repeated at various intervals. Strategies may be re-scored and/or re-selected continually, intermittently, and/or otherwise, in an attempt, for example, to transport the loads as similarly to the desired behaviors as possible. In some embodiments, the strategies may be re-scored and/or re-selected whenever a new desired behavior is determined for one or more loads.

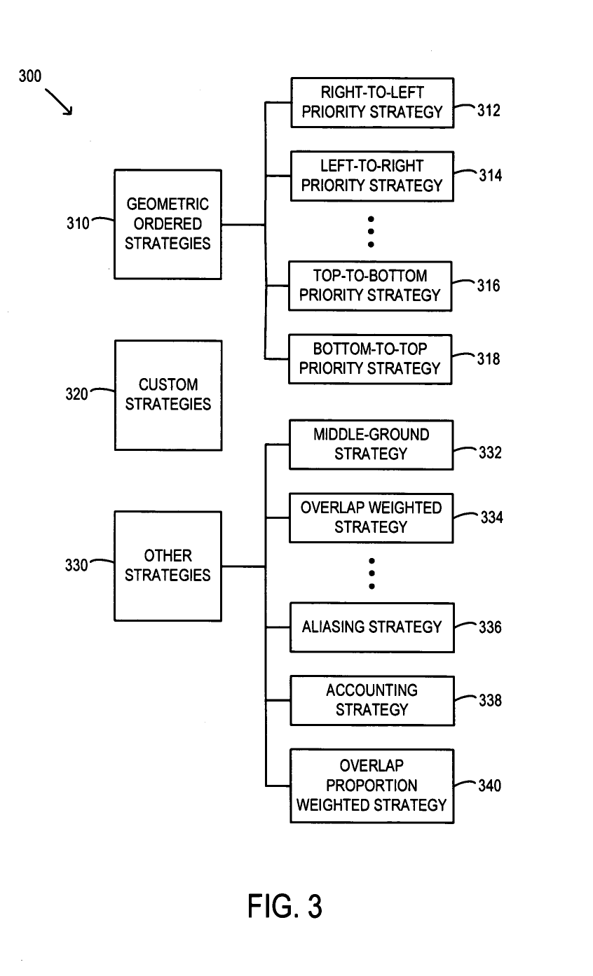

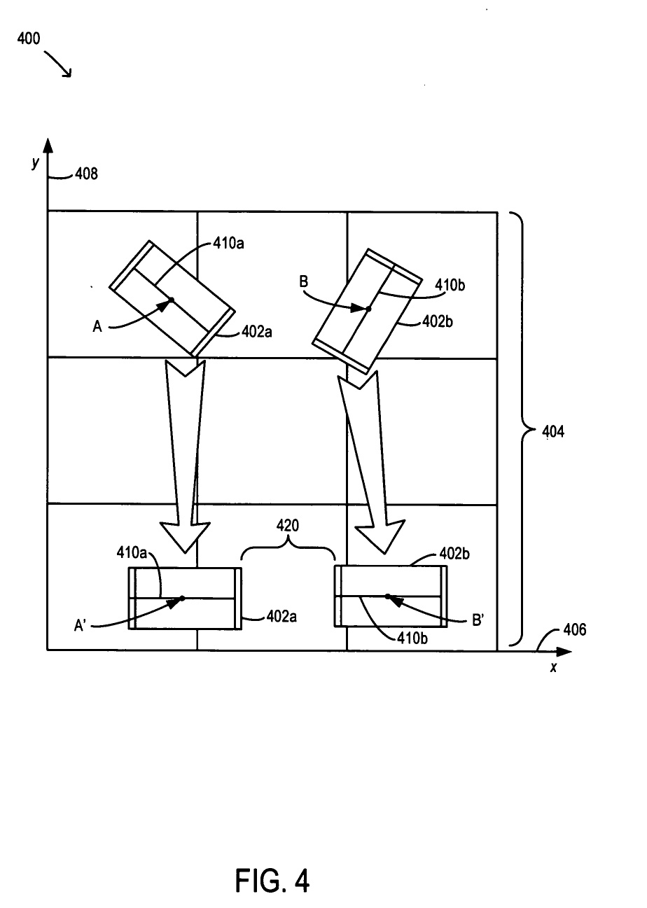

Turning now to FIG. 3 (with continued reference to FIG. 1), a block diagram of a plurality of example actuator control strategies 300 according to some embodiments is shown. The actuator control strategies 300 may, for example, be utilized in, scored, selected, and/or applied in accordance with any of the methods 200, 600, 700, 800, 900, 1100 described herein. In some embodiments, fewer or more strategies than those shown in FIG. 3 may be included in the plurality of strategies 300. For example, in some load processing systems it may be known that only certain strategies are likely to produce desirable results. In other systems it may be desirable to consider all known or available strategies.

According to some embodiments, the strategies 300 may include geometric ordered strategies 310, custom strategies 320, and/or other strategies 330. The geometric ordered strategies 310 may include, but are not limited to, a right-to-left priority strategy 312, a left-to-right priority strategy 314, a top-to-bottom priority strategy 316, and/or a bottom-to-top priority strategy 318.

In the right-to-left priority strategy 312, for example, all loads desired to be transported (such as loads 102a-c) may be considered geometrically (e.g., in relation to one or more actuators, reference points or lines, and/or other system components) from right to left as they are positioned in the load processing system (such as systems 100, 400, 500). For example, in a right-to-left priority strategy 312 the loads 102a-c of system 100 may be considered starting with the right-most load 102c, then considering the next load 102b, and ending with the left-most load 102a. In some embodiments, any actuator that the currently considered load overlaps may be set to, assigned, and/or otherwise associated with a motion vector (speed and direction) such as a motion vector associated with the desired load behavior. For consecutively considered loads where an overlapping actuator has previously been assigned a vector (i.e., the actuator is overlapped by both the currently considered load and a previously considered load), the actuator may be re-assigned a motion vector associated with the desired behavior for the current load.

In some embodiments, a multiple-overlapped actuator may not be assigned a new vector. For example, the priority of the loads may be considered in the decision regarding what setting the actuator should be assigned. In some embodiments, the actuator may be assigned a vector that is an average (or other computational, statistical, and/or mathematical function) of any competing vectors (similar to the middle-ground strategy 332 described below). According to some embodiments, actuators with no overlapping loads may be, for example, assigned no motion vector (e.g., remain and/or become idle) or assigned a motion vector associated with other surrounding, nearby, and/or desired motion vectors.

According to some embodiments, the other geometric ordered strategies 314, 316, 318 may be conducted similarly to the right-to-left strategy 312 described above, except that the order of considering loads would be as described in the name of each strategy. In some embodiments, other geometric ordered strategies 310 may also or alternatively be considered. For example, other strategies may be associated with diagonal and/or other coordinate directions, third dimensions, and/or may be combinations of any number of geometric ordered strategies 310 that are or become known.

In some embodiments, custom strategies 320 may be considered. Custom strategies 320 may include, for example, strategies tailored to particular actuator types, arrangements, and/or configurations. Custom strategies 320 may, in some embodiments, be designed specifically for a particular factory, warehouse, or other assembly line using a specific matrix of actuators. In some embodiments, custom strategies 320 may be or include combinations of other strategies such as any strategies that are described herein and/or are or become known.

According to some embodiments, other strategies 330 that may not be geometrically ordered may be considered. Other strategies 330 may include, for example, a middle-ground strategy 332, an overlap weighted strategy 334, an aliasing strategy 336, an accounting strategy 338, and/or an overlap proportion weighted strategy 340. In some embodiments, any or all of these other strategies 330 may consider loads and/or actuators in any order (e.g., not geometrically). The middle-ground strategy 332, for example, may assign a motion vector such as the desired motion vector to any actuator that is overlapped by one load and/or by no loads. For actuators that are overlapped by more than one load, the actuator may be assigned, for example, a motion vector that is an average of the desired vectors for each of the overlapping loads. Other compromise settings for the actuator may be determined by taking into account, for example, the priority of the overlapping loads and/or other load or actuator factors.

In some embodiments, the overlap weighted strategy 334 may similarly assign any non-overlapped and/or singly-overlapped actuator a motion vector such as a preferred and/or desired motion vector (e.g., a motion vector associated with a desired behavior of an overlapping or nearby load). For actuators that are overlapped by more than one load, the actuator may be set, for example, to the desired motion vector associated with the load having the greatest overlap of the actuator. According to some embodiments, where two loads have the same or substantially the same overlap, a compromise between their desired vectors may be applied to the actuator (e.g., by using another strategy such as the middle-ground strategy 322 for the two or more similarly overlapping loads).

According to some embodiments, the aliasing strategy 336 may be or include a combination of the middle-ground strategy 332 and the overlap weighted strategy 334. For example, any actuators that are overlapped by one and/or no loads may be assigned a desired vector (or no vector, in the case of an actuator not being overlapped). Where two or more loads overlap an actuator, the average vector may be determined, for example, by weighting the respective desired load vectors by the amount of overlap associated with each respective overlapping load (like in the overlap weighted strategy 334), and then by averaging (like in the middle-ground strategy 332) the resulting weighted vectors.

In some embodiments, an accounting strategy 338 may be considered. For example, any non-overlapped and/or singly-overlapped actuator may be assigned an appropriate vector such as a desired vector. Each load may also be assigned an account which may, for example, be set at a value of zero. Where an actuator is overlapped by more than one load, the actuator may be assigned the vector associated with the load with the largest account. Where the overlapping loads have equal accounts (such as initially, when all loads may have accounts set at zero), a load may be chosen randomly and/or by other means. The account of any overlapping load that was not chosen may then be incremented. The process of the strategy may then be repeated, for example, each time giving priority to loads that were previously not necessarily moved in their desired directions (i.e., those with incrementally larger accounts).

According to some embodiments, other factors may be considered in various strategies. For example, the overlap proportion weighted strategy 340 may also or alternatively consider all actuators in any order, and may also or alternatively assign no-overlap and/or single-overlap actuators a desired motion vector (as in the other strategies described herein). The proportion weighted strategy 340 may, in some embodiments, also or alternatively take into account other factors such as load size. For example, where two or more loads overlap an actuator, the load with the greatest proportion of actuator overlap to total load size may be identified. In some embodiments, the actuator may then be assigned the desired vector associated with the identified load.

Other factors, variables, metrics, and/or criteria may similarly be used in various actuator control strategies. Indeed, large numbers of potential strategies are possible. Any number and/or combination of strategies may be utilized in carrying out the embodiments described herein. In some embodiments, one or more strategies may be pre-determined and/or identified prior to certain events. For example, strategies may be determined prior to coloring, scoring, and/or selecting a strategy in accordance with method 200 herein. According to some embodiments, one or more strategies may be determined during and/or after certain events. For example, one or more strategies may be determined after a strategy has been colored, scored, and/or selected in accordance with method 200. In other words, strategies may be ad-hoc and/or determined on-the-fly, utilizing, for example, information regarding previous strategy performances and/or current load positions, velocities, and/or directions (e.g., load behaviors).

In some embodiments, a chosen and/or applied strategy may require an actuator to be set to a specific speed and/or direction (a motion vector). In some systems and/or configurations however, an actuator may not be capable of performing exactly as required by the given strategy. In such conditions, the actuator may be set, for example, to speeds and/or directions similar and/or close to those specified by the strategy. In some embodiments it may not be possible for a strategy to require an unattainable setting for an actuator because the strategy may be limited to selecting settings within actuator constraints.

Turning now to FIG. 4, a block diagram of a system 400 for processing loads according to some embodiments is shown. The system 400 may, for example, be similar in configuration and/or functionality to and/or otherwise be associated with any of the systems 100, 500, 1000, 1200 described herein. According to some embodiments, the system 400 may conduct and/or operate in accordance with any of the methods 200, 600, 700, 800, 900, 1100 described herein. According to some embodiments, the components 402, 404, 406, 408, 410 may be similar in configuration and/or functionality to the similarly-named components described in conjunction with any of FIG. 1, FIG. 5, and/or FIG. 10. In some embodiments, fewer or more components that are shown in FIG. 4 may be included in the system 400.

In some embodiments, the system 400 may include one or more loads 402 (such as first and second loads 402a, 402b, respectively) controlled by a matrix of actuators 404. The positions and/or other behaviors of the loads 402 may, according to some embodiments, be described in accordance with a coordinate system such as that defined by the x-axis 406 and the y-axis 408 (e.g., similar to the other axes 106, 108, 506, 508 described herein). The simple two-dimensional coordinate system shown in FIG. 4 (and used throughout herein) is presented for ease of explanation. Other coordinate systems and/or dimensions may be used to describe load 402 behaviors without deviating from some embodiments. Rotational behaviors of the loads 402 may, in some embodiments, be described with reference to a centerline 410 of the loads 402.

According to some embodiments, desired behaviors for the loads 402 may include explicit behaviors, relative behaviors, and/or hybrid behaviors (e.g., a combination of explicit and relative behaviors). For example, a user may specify that the first load 410a is desired to be moved from location A to location A′ (as indicated by the associated arrow in FIG. 4). In some embodiments (such as shown in FIG. 4), the user may also specify that the first load 402a is to change orientation. The first load 402a may, for example, be desired to rotate from the orientation shown at position A to the substantially coordinately-aligned orientation shown at location A′. The first load 402a may need to be coordinately-aligned, for example, to prepare the first load 402a to enter a machine and/or device or other area (e.g., a packing machine with an entrance located along the x-axis 406). In some embodiments, each of these behaviors (and/or the combination of the two behaviors) may be considered explicit behaviors.

As an example of a hybrid behavior, the user may specify, in some embodiments, that the second load 402b is desired to change orientation to become substantially coordinately-aligned and that the second load 402b is to move from location B to location B′ (e.g., explicit behaviors). In some embodiments, the user may also (or alternatively) specify that the second load 402b should be separated from the first load 402a by a separation distance 420 (e.g., a relative behavior). In some embodiments, the user may further specify, for example, that the second load 402b is to be maintained at the separation distance 420 which is to be measured in a specific direction (e.g., positively along the x-axis 406). The user may also or alternatively specify that the separation distance 420 is desired to be attained by the time the second load reaches location B′ (e.g., as shown in FIG. 4).

According to some embodiments, the separation distance 420 may be directly specified by a user and/or may be determined by the system 400 and/or an associated entity or component. The separation distance 420 may, for example, be determined based upon the requirements of a system component located at and/or near the x-axis 406. As described elsewhere herein, for example, the system component may be or include a machine such as a packaging machine, the entrance of which is located along and/or proximate to the x-axis 406. In such embodiments, the separation distance 420 may, for example, be defined by the specifications and/or requirements of the packaging machine.

For example, the packaging machine may accept packages (e.g., loads 402) in pairs that are required to be separated by the distance 420 in order for the machine to function properly. As another example, the machine may have an entrance located along the y-axis 408 adjacent to the actuator bordering both the y-axis 408 and the x-axis 406. In such an embodiment, the various behaviors (explicit, relative, hybrid) of the loads 402 may be determined to align the loads 402 for single-file entrance into the machine. The separation distance 420 may, according to such an embodiment, be a distance to be maintained between loads to allow the machine enough time to process the first load 402a prior to the second load 402b entering the machine.

Referring now to FIG. 5, a graphical diagram of a system 500 for processing loads according to some embodiments is shown. The system 500 may, for example, be similar in configuration and/or functionality to and/or otherwise be associated with any of the systems 100, 400, 1000, 1200 described herein. According to some embodiments, the system 500 may conduct and/or operate in accordance with any of the methods 200, 600, 700, 800, 900, 1100 described herein. According to some embodiments, the components 502, 506, 508 may be similar in configuration and/or functionality to the similarly-named components described in conjunction with any of FIG. 1, FIG. 4, and/or FIG. 10. In some embodiments, fewer or more components that are shown in FIG. 5 may be included in the system 500.

In some embodiments, the system 500 may include a first load 502a and a second load 502b, the locations and/or other behaviors of which are described using the coordinate system defined by the x-axis 506 and the y-axis 508 (e.g., similar to the other axes 106, 108, 406, 408 described herein). The loads 502 may, according to some embodiments, be moveable by a plurality of load actuators (such as the matrix of load actuators 404 of FIG. 4). For ease of explanation, no actuators are shown in FIG. 5.

In some embodiments, the loads 502a, 502b may be initially (e.g., at the beginning of a time period or cycle) positioned at locations A and B, respectively. According to some embodiments, desired behaviors for the loads 502 may be determined (e.g., at 202 of method 200). In some embodiments for example, a user may specify that the first load 502a is desired to move from location A to location A_{d} (e.g., the “desired” location for the first load 502a). The user may also specify, for example, that the second load 502b is to be positioned a certain distance 520 away from the first load 502a (e.g., a relative behavior).

Because the coordinate system used in FIG. 5 is two-dimensional and the user has specified a one-dimensional relative behavior for the second load 502b, there are a number of potential locations that would meet the user's criteria. In other words, the second load 502b may be maintained at the distance 520 from the desired location A_{d} of the first load 502a if the second load is located anywhere on the circle 522. Thus, the circle 522 represents the possible locations that may be considered “desired” locations B_{d} for the second load 502b. Other criteria specified by the user may alter the configuration of the circle 522 and/or the locations that may be acceptable for the desired locations B_{d} for the second load 502b. If the user specifies that the second load 502b is to be maintained at the distance 520 behind the first load 502a, for example, the circle 522 may become a semi-circle, arc, and/or other shape or line as appropriate to define acceptable desired locations B_{d} for the second load 502b.

In some embodiments, the desired behavior of the first load 502a may be represented by the behavior line 530. The behavior line 530, for example, may represent the desired translation of the first load 502a from the location A to the desired location A_{d}. In some embodiments, the behavior line 530 may also or alternatively represent other desired load behaviors such as load rotation, load velocity, and/or load acceleration. According to some embodiments, other descriptors (graphical or otherwise) may be used in addition to and or in place of the behavior line 530 to represent the desired behavior of the first load 502a.

In some embodiments, such as where a strategy is scored, the actual behaviors that loads (such as loads 502) may experience may be unknown. Before a strategy is implemented, for example, the load may be static and thus it may only be known where the load is and/or where the load is desired to go (and/or how the load is otherwise desired to behave). In such embodiments, the expected behaviors of the loads 502 for any given strategy may be predicted (i.e., the loads may be colored). Prediction of load 502 behaviors where desired explicit behaviors have been specified (e.g., for the first load 502a) may involve, according to some embodiments, simulating and/or otherwise predicting how the strategy would cause the load 502 to behave. In some embodiments for example, the strategy may utilize the desired behavior of the load (like the desired behavior line 530 for the first load 502a) in accordance with strategy rules and/or parameters to move the load 502.

In some embodiments, the expected behavior of a “servient” load (e.g., a load associated with a desired relative behavior, such as the second load 502b) may need to be determined (e.g., in accordance with strategy rules) prior to predicting the behavior of a “dominant” load (e.g., a load upon which the servient load depends, such as the first load 502a). In other words, a strategy may require the servient load to be colored prior to coloring the associated dominant load (and/or dominant loads). As an example, assuming a particular strategy is simulated that requires the second load 502b to be evaluated first (e.g., the right-to-left priority strategy 612), an expected (e.g., “predicted”) location Bₚ for the second load 502b may be determined with respect to the desired location A_{d} of the first load 502a. In other words, because the first load 502a has not yet been colored, only the desired location A_{d} (and/or current location, A) of the first load 502a may be known.

For example, where the desired relative behavior for the second load 502b includes the one-dimensional criteria that the second load 502b be maintained at a distance 520 from the first load 502a, the circle 522 may be determined that represents the possible locations that satisfy the relative criteria and would be appropriate desired locations B_{d} of the second load 502b (e.g., with respect to the desired location A_{d} of the first load 502a). The behavior lines 532 may, according to some embodiments, represent the potential desired behaviors of the second load 502b (e.g., associated with the various potential desired locations B_{d} of the second load 502b). In some embodiments, based on the desired locations B_{d} of the second load 502b, a predicted location Bₚ for the second load under the strategy may be determined. The behavior line 534 may, for example, represent the behavior of the second load 502b that is expected under the strategy.

In some embodiments, the expected behavior of the dominant load (e.g., the first load 502a) may need to be determined prior to predicting the behavior of a servient load (e.g., the second load 502a). As an example, assuming a particular strategy is simulated that requires the first load 502a to be evaluated first (e.g., the left-to-right priority strategy 614), an expected (e.g., “predicted”) location Aₚ for the first load 502a may be determined. The predicted and/or expected behavior of the first load 502a may, according to some embodiments, be represented by the behavior line 536 (which shows the first load 502a moving from location A to location Ap). In some embodiments, the expected behavior of the second load 502b may then be determined based upon the predicted location Aₚ of the first load 502a. For example, because the desired behavior of the second load 502b is relative to the first load 502a (i.e., dependent upon the first load 502a), and a prediction has been made as to where the first load will be (e.g., once and/or after the strategy is implemented), the predicted location Aₚ of the first load 502a may be used to determine one or more “actual desired” locations B_{ad} for the second load. In other words, because the first load 502a is colored prior to coloring the second load 502b, the second load 502b may be colored using the predicted location Aₚ of the first load 502a (e.g., instead of the desired location A_{d} of the first load 502a).

Where the desired relative behavior for the second load 502b includes the one-dimensional criteria that the second load 502b be maintained at a distance 520 from the first load 502a, for example, a circle 538 may be determined that represents the possible locations that satisfy the relative criteria and would be appropriate actual desired locations B_{ad} of the second load 502b (e.g., with respect to the predicted location Aₚ of the first load 502a). The behavior lines 540 connecting location B to the various actual desired locations B_{ad} for the second load 502b may, in some embodiments, represent the actual desired behaviors for the second load 502b.

According to some embodiments, the actual desired behaviors of the second load 502b (e.g., as represented by the behavior lines 540) may be utilized to predict how the strategy would cause the second load 502b to behave. The predicted location Bₚ of the second load 502b may, for example, be determined (i.e., the second load 502b may be colored). In some embodiments, the predicted behavior of the second load 502b may be represented by the behavior line 534. According to some embodiments, strategies that allow the dominant load to be predicted (e.g., colored) first may result in more accurate predictions for the servient load. In other words, when the predicted position of the dominant load is known, the servient load behavior may be more accurately predicted than if only the desired behavior of the dominant load is known (e.g., because the expected behavior of the dominant load may deviate from the desired behavior of the dominant load, causing a deviation in the relative “actual desired” behaviors for the servient load).

In some embodiments, after the loads are colored, the desired and/or predicted behaviors of the loads 502 may be utilized to score the strategy. Deviations may be calculated and/or otherwise determined, for example, between the desired and predicted behaviors for the loads 502. In some embodiments, deviations between any desired and/or predicted metrics may be determined. For example, deviations between velocities, translations, rotations, accelerations, and/or other metrics may be identified and/or quantified. As an example, the deviation 550 between the desired location A_{d} of the first load and the predicted location Aₚ of the first load 502a may be determined. In some embodiments, this deviation may be utilized in scoring the strategy.

In embodiments where a one-dimensional desired relative behavior has been specified (e.g., for the second load 502b), several, multiple, and/or a plurality of potential locations may satisfy the relative criteria (as described herein). Each actual desired location B_{ad} for the second load 502b, for example, may be associated with a deviation from the predicted location Bₚ for the second load 502b. In some embodiments, one or more of the possible deviations may be chosen to use in scoring the strategy. According to some embodiments for example, the actual desired location B_{ad} that is associated with the smallest deviation 552 from the predicted location Bₚ for the second load 502b may be selected. The behavior line 554 may, for example, represent the actual desired behavior of the second load 502b (e.g., for scoring purposes, since the first load 502a has already been colored, the predicted location Aₚ of the first load 502a may be used to determine the potential actual desired locations B_{ad} for the second load 502b). In some embodiments, the smallest deviation 552 may be utilized in scoring the strategy. The smallest deviation 552 for the second load 502b may, for example, be added with the deviation 550 for the first load 502a to score the strategy.

Referring now to FIG. 6, a flowchart of a method 600 according to some embodiments is shown. The method 600 may, according to some embodiments, begin by scoring an actuator control strategy, at 602. The method 600 (and/or scoring at 602) may, for example, be included as part of the method 200 described herein. In particular, the scoring of an actuator control strategy at 602 may, according to some embodiments, be (or be similar to) the scoring at 204 described in conjunction with FIG. 2 herein. In some embodiments, the method 600 may be associated with any of the systems 100, 400, 500, 1000, 1200 described herein. The method 600 may begin, for example, at 602 where an actuator control strategy (“s”) may be scored. In some embodiments, the method 600 may be repeated to score each of a plurality of known or available actuator control strategies.

In some embodiments, the actuator control strategy (“s”) may be scored by coloring and/or scoring each load (“i”) of the load processing system, at 604. According to some embodiments, the coloring and/or scoring of each particular load (“i”) at 604 may begin by determining a load command type at 606. For example, a command specified by a user may indicate that the load (“i”) is to perform in accordance with one or more explicit, relative, and/or hybrid behaviors (e.g., as described herein). In some embodiments, other types, quantities, configurations, and/or combinations of commands may be determined. According to some embodiments, a command type may be determined for each command and/or behavior associated with the load (“i”).

At 608, the method 600 may continue by determining if the load command type is explicit. If the command type is explicit, then the method 600 may continue by determining a desired behavior (“B_{d}”) of the load (“i”) at 610. In some embodiments, the desired behavior (“B_{d}”) determined at 610 may include the explicit behavior defined by and/or otherwise associated with the explicit command type for the load (“i”). According to some embodiments, once the desired behavior (“B_{d}”) is determined, the method 600 may continue by predicting the behavior (“Bₚ”) of the load (“i”) under the strategy (“s”), at 612. Processing under the method 600 may then continue, for example, by proceeding to point A (described in conjunction with FIG. 7 herein).

If the command type is determined at 608 not to be explicit, then processing under the method 600 may continue, according to some embodiments, at 614 by determining a desired relative behavior (“B_{drs}”) of the sevient load (“iₛ”). At 616 the method 600 may determine if the predicted behavior (“B_{pd}”) of the dominant load (“i_{d}”) has already been determined (e.g., in an earlier iteration of scoring loads for the strategy (“s”)). If the predicted behavior (“B_{pd}”) of the dominant load (“i_{d}”) has already been determined, then processing may continue at 618 by determining a number (“N”) of potential desired behaviors (“B_{ds}”) for the servient load (“iₛ”).

The potential desired behaviors (“B_{ds}”) for the servient load (“iₛ”) may, for example, be behaviors that satisfy the desired relative behavior (“B_{drs}”) of the servient load (“iₛ”) with respect to the predicted behavior (“B_{pd}”) of the dominant load (“i_{d}”). In some embodiments, once the potential desired behaviors (“B_{ds}”) for the servient load (“iₛ”) are determined, processing may continue at 620 by predicting the behavior (“Bₚₛ”) of the servient load (“iₛ”) under the strategy (“s”). Processing under the method 600 may then continue, for example, by proceeding to point B (described in conjunction with FIG. 8 herein).

If it is determined at 616 that the predicted behavior (“B_{pd}”) of the dominant load (“i_{d}”) has not yet been determined (e.g., the servient load (“iₛ”) is processed under the strategy prior to the dominant load (“i_{d}”)), in some embodiments processing under the method 600 may continue at 622 by determining a number (“N”) of potential desired behaviors (“B_{ds}”) for the servient load (“iₛ”).

The potential desired behaviors (“B_{ds}”) for the servient load (“iₛ”) may, for example, be behaviors that satisfy the desired relative behavior (“B_{drs}”) of the servient load (“iₛ”) with respect to the desired behavior (“B_{dd}”) of the dominant load (“i_{d}”). In other words, because the predicted behavior (“B_{pd}”) of the dominant load (“i_{d}”) has not yet been determined under the strategy (“s”), the potential desired behaviors (“B_{ds}”) of the servient load (“iₛ”) may, according to some embodiments, be determined based upon the desired behavior (“B_{dd}”) of the dominant load (“i_{d}”). In some embodiments, once the potential desired behaviors (“B_{ds}”) for the servient load (“iₛ”) are determined, processing may continue at 620 by predicting the behavior of the servient load (“iₛ”) under the strategy (“s”). Processing under the method 600 may then continue, for example, by proceeding to point B (described in conjunction with FIG. 8 herein).

Referring now to FIG. 7, a flowchart of a method 700 according to some embodiments is shown. In some embodiments, the method 700 may be associated with any of the systems 100, 400, 500, 1000, 1200 described herein. The method 700 may begin, for example, at 702 where an actuator control strategy (“s”) may be scored. In some embodiments, the method 700 may be repeated to score each of a plurality of known or available actuator control strategies. In some embodiments, the actuator control strategy (“s”) may be scored by scoring each load (“i”) of the load processing system, at 704. According to some embodiments, the processes performed at 702 and/or 704 may be similar to those practiced at 602 and/or 604 of the method 600 described herein. In some embodiments, the method 700 may begin at point A as a continuation of the method 600.

According to some embodiments for example, the scoring of each particular load (“i”) at 704 may begin by determining, at 730, any translational difference (“Tᵢ”) and/or, at 732, any rotational difference (“Rᵢ”) expected for the particular load (“i”). For example, the desired behavior (“B_{d}”) of the load (“i”) may include a desired destination and/or a desired rotational orientation. The expected destination and/or rotational orientation of the load using a particular strategy (“s”) (e.g., the predicted behavior (“Bₚ”)) may, according to some embodiments, be predicted. The difference between the predicted behavior (“Bₚ”) (e.g., the expected locations and/or rotational orientations) and the desired behavior (“B_{d}”) may then be determined.

In some embodiments, these differences (“Tᵢ”, “Rᵢ”) may be converted to translational and/or rotational scores, respectively. The scores may, for example, be or include the actual differences (“Tᵢ”, “Rᵢ”) and/or may be representative and/or indicative of the differences (e.g., scored on a scale from one to ten). In some embodiments, both of the translational and rotational differences may be scored, determined, and/or considered as a single value, entity, metric, and/or criteria. According to some embodiments, a single difference, deviation, and/or score may be determined based upon the differences between the predicted behavior (“Bₚ”) and the desired behavior (“B_{d}”).

The method 700 may continue, in some embodiments, by weighting the translational difference (“Tᵢ”) at 734 and/or by weighting the rotational difference (“Rᵢ”) at 736. For example, each of the differences (“Tᵢ”, “Rᵢ”) may be multiplied by a respective weighting factor (“Wₜ”, “Wᵣ”). The weighting factors (“Wₜ”, “Wᵣ”) may be entered and/or defined by a user and/or may be empirically determined for a particular load processing system, matrix of actuators, and/or actuator. In some embodiments, the weighting factors (“Wₜ”, “Wᵣ”) may be at least partially determined based upon the ability of a particular actuator to correct errors in the respective kinds of motion (i.e., translational and/or rotational motions). According to some embodiments, a value for the translational weighting factor (“Wₜ”) may be equal to or substantially equal to two times the value of the rotational weighting factor (“Wᵣ”). Such a relationship between the weighting factors (“Wₜ”, “Wᵣ”) may indicate, for example, that it is approximately twice as difficult for an actuator to compensate for translational deviations as it is to compensate for rotational deviations.

In some embodiments, the method 700 may continue at 738 where the weighted differences are summed (“WₜTᵢ+WᵣRᵢ”). The sum of the weighted differences (“WₜTᵢ+WᵣRᵢ”) may then, for example, be squared at 740 (“(WₜTᵢ+WᵣRᵢ)²”). In some embodiments, the squaring at 740 may, for example, cause larger deviations to be more heavily weighted. This may ultimately cause the scoring of various strategies to be similar to a ‘least squares fit’. Such a fit may, for example, facilitate the ultimate selection of an appropriate strategy to apply to a given matrix of actuators.

The method 700 may continue by determining various factors associated with the load (“i”). For example, at 742, the method 700 may include determining a proximity of the load (“i”) to a critical line (“C”). The critical line (“C”) may be a line, for example, that represents the possibility that the load (“i”) may reach the desired destination. Where individual actuators in a matrix of actuators are only capable of moving loads in certain directions (like forward, for example), one side of the critical line (“C”) may indicate an area where the load (“i”) may be able to reach the desired destination, while the other side of the line (“C”) may represent an area in which the load (“i”) may not be able to reach the desired destination.

In other words, once the load (“i”) passes the desired destination, if the actuators are not capable of reverse movement, the load (“i”) will not be able to reach the destination. Therefore, in some embodiments, it may be important to ensure that loads are kept away from critical lines (“C”). The closer a load (“i”) is moved to a critical line (“C”) using the current strategy, for example, the higher the proximity to the critical line factor (“Cᵢ”may be. In some embodiments for example, the critical line factor (“Cᵢ”) may be expressed in terms of a probability (e.g., a factor of eighty percent representing an eighty percent chance that the load will reach the critical line (“C”)). According to some embodiments, the critical line factor (“Cᵢ”) may be expressed in terms of the shortest distance between the load (“i”) and the critical line (“C”).

At 744, the method 700 may include determining a possibility of the load (“i”) becoming isolated from other loads (“Iᵢ”). The load (“i”) may, for example, be associated with one or more other loads. In some embodiments, these loads may be or include a load set, group, or collection (such as a load consisting of a collection of vehicle windshields). It may be desirable to keep any associated loads, such as loads belonging to the same collection, together. In some embodiments, the possibility of isolation factor (“Iᵢ”) increases the closer a load (“i”) is to being isolated from other loads (like loads of the same collection) using the current strategy.

According to some embodiments however, it may be desirable that a particular load become and/or remain isolated from other loads. Volatile, reactive, fragile, and/or otherwise desirably isolated loads may, for example, need to be kept away from other loads and/or other load types. In some embodiments therefore, the possibility of isolation factor (“Iᵢ”) increases the closer a load (“i”) is to other loads. In other words, if the load (“i”) is far from being isolated from other loads, the higher the possibility of isolation factor (“Iᵢ”) may be for that load (“i”) using the current strategy. The possibility of isolation factor (“Iᵢ”) may be expressed in any terms, and/or metrics such as, for example, probabilities, distances, and/or ranks. In some embodiments, the possibility of isolation factor (“Iᵢ”) may be specified directly by a user. This may occur, for example, if a user specifies a desired relative behavior (“B_{drs}”) for a servient load (“iₛ”) that includes a specified separation distance (e.g., distance 420, 520) between loads. In some embodiments, the possibility of isolation factor (“Iᵢ”) may otherwise be associated with relative behaviors of loads.

In some embodiments, the method 700 may include determining a user-specified weight (“Uᵢ”) to be applied to the load (“i”), at 746. For example, a user, operator, and/or programmer may desire to expedite the transportation and/or other processing of a particular load (“i”) and/or load type. The user may use any interface that is or becomes known to enter, reference, and/or otherwise define the desired priority or weight (“Uᵢ”) to be assigned to the load (“i”). The user-specified weight (“Uᵢ”) may be expressed in any terms, and/or metrics such as, for example, probabilities, scores, and/or ranks.

The method 700 may continue, for example, at 748 by multiplying various load factors. As shown in FIG. 7, the squared sum of the weighted differences (“(WₜTᵢ+WᵣRᵢ)²”), the proximity to the critical line factor (“Cᵢ”), the possibility of isolation factor (“Iᵢ”), and the user-specified weight (“Uᵢ”) may all be multiplied at 748 (“CᵢIᵢUᵢ(WₜTᵢ+WᵣRᵢ)²”). In some embodiments, fewer or more factors than those shown in FIG. 7 may be included in the calculation at 748. According to some embodiments, the calculation at 748 may be or include an addition and/or other mathematical operation instead of or in addition to the multiplicative operation shown.

According to some embodiments, the calculation at 748 may directly result in a score for a particular load (“Sᵢ”), at 750. In some embodiments, the score for the load (“Sᵢ”) may be determined at 750 based on or at least partially based on the calculation at 748. For example, the product realized at 748 may be converted to a load score (“Sᵢ”) at 750. In some embodiments, the product from 748 may be looked up in a table and/or database to determine an associated score for the load (“Sᵢ”). Other operations, functions, and/or procedures may be used at 750 to produce a load score (“Sᵢ”) based at least partially upon the resulting value(s) from 748. Processing under the method 700 may then continue, for example, by proceeding to point C (described in conjunction with FIG. 9 herein).

Turning now to FIG. 8, a flowchart of a method 800 according to some embodiments is shown. In some embodiments, the method 800 may be associated with any of the systems 100, 400, 500, 1000, 1200 described herein. The method 800 may begin, for example, at 802 where an actuator control strategy (“s”) may be scored. In some embodiments, the method 800 may be repeated to score each of a plurality of known or available actuator control strategies. In some embodiments, the actuator control strategy (“s”) may be scored by scoring each load (“i”) of the load processing system, at 804. According to some embodiments, the processes performed at 802 and/or 804 may be similar to those practiced at 602, 702 and/or 604, 704 of the methods 600, 700 described herein. In some embodiments, the method 800 may begin at point B as a continuation of the method 600.

According to some embodiments for example, the scoring of each particular load (“i”) at 804 may begin by determining, at 822, any differences for each of the potential desired behaviors (“B_{ds}”) of a servient load (“iₛ”) For example, where one-dimensional relative behaviors are desired for the servient load (“iₛ”), multiple possible behaviors (“B_{ds}”) may satisfy the relative criteria. At 822, each such potential desired behavior (“B_{ds}”) for the servient load (“iₛ”) may be evaluated to determine any deviations that are likely under the strategy (“s”). At 824, the minimum of the deviations for the potential desired behavior (“B_{ds}”) for the servient load (“iₛ”) may be determined. In some embodiments, other mathematical functions and/or procedures may be used in addition to or in place of taking the minimum at 824.

In some embodiments, the determining at 822 may include determining a translational difference (“Tᵢ”) at 830 and/or determining a rotational difference (“Rᵢ”) at 832. The translational and/or rotational differences (“Tᵢ”, “Rᵢ”) may, for example, be determined based on differences between each particular potential desired behavior (“B_{ds}”) of the servient load (“iₛ”) and the predicted behavior (“Bₚₛ”) of the servient load (“iₛ”) under the strategy (“s”). In some embodiments, the minimum translational and/or rotational differences (“Tₘᵢₙ”, “Rₘᵢₙ”) may be selected at 826 and/or 828, respectively.

The single potential desired behavior (“B_{ds}”) associated with the smallest translational and rotational differences (“Tₘᵢₙ”, “Rₘᵢₙ”) may, for example, be identified and/or selected. In some embodiments, more than one potential desired behavior (“B_{ds}”) may be identified. One potential desired behavior (“B_{ds}”) may, for example, be associated with the minimum translational difference (“Tₘᵢₙ”), while another potential desired behavior (“B_{ds}”) may be associated with the minimum rotational difference (“Rₘᵢₙ”). According to some embodiments, the minimums for translation and rotation (“Tₘᵢₙ”, “Rₘᵢₙ”) may be selected independently. While in some embodiments only a single potential desired behavior (“B_{ds}”) having the minimum overall difference (“TRₘᵢₙ”) may be selected.

In some embodiments, the method 800 may continue by weighting the translational difference (“Tᵢ”) at 834 and/or by weighting the rotational difference (“Rᵢ”) at 836. For example, each of the differences (“Tᵢ”, “Rᵢ”) may be multiplied by a respective weighting factor (“Wₜ”, “Wᵣ”). The weighting factors (“Wₜ”, “Wᵣ”) may be entered and/or defined by a user and/or may be empirically determined for a particular load processing system, matrix of actuators, and/or actuator. In some embodiments, the weighting factors (“Wₜ”, “Wᵣ”) may be similar to the weighting factors (“Wₜ”, “Wᵣ”) described in relation to the method 700 described herein.

In some embodiments, the method 800 may continue at 838 where the weighted differences are summed (“WₜTᵢ+WᵣRᵢ”). The sum of the weighted differences (“WₜTᵢ+WᵣRᵢ”) may then, for example, be squared at 840 (“(WₜTᵢ+WᵣRᵢ)²”). The method 800 may continue by determining various factors associated with the load (“i”). For example, at 842, the method 800 may include determining a proximity of the load (“i”) to a critical line factor (“Cᵢ”). At 844, the method 800 may include determining a possibility of the load (“i”) of becoming isolated from other loads factor (“Iᵢ”). In some embodiments, the method 800 may also or alternatively include determining a user-specified weight (“Uᵢ”) to be applied to the load (“i”), at 846.

The method 800 may continue, for example, at 848 by multiplying various load factors. As shown in FIG. 8, the squared sum of the weighted differences (“(WₜTᵢ+WᵣRᵢ)²”), the proximity to the critical line factor (“Cᵢ”), the possibility of isolation factor (“Iᵢ”), and the user-specified weight (“Uᵢ”) may all be multiplied at 748 (“CᵢIᵢUᵢ(WₜTᵢ+WᵣRᵢ)²”). In some embodiments, fewer or more factors than those shown in FIG. 8 may be included in the calculation at 848. According to some embodiments, the calculation at 848 may be or include an addition and/or other mathematical operation instead of or in addition to the multiplicative operation shown.

According to some embodiments, the calculation at 848 may directly result in a score for a particular load (“Sᵢ”), at 850. In some embodiments, the score for the load (“Sᵢ”) may be determined at 850 based on or at least partially based on the calculation at 848. For example, the product realized at 848 may be converted to a load score (“Sᵢ”) at 850. In some embodiments, the product from 848 may be looked up in a table and/or database to determine an associated score for the load (“Sᵢ”). Other operations, functions, and/or procedures may be used at 850 to produce a load score (“Sᵢ”) based at least partially upon the resulting value(s) from 848. Processing under the method 800 may then continue, for example, by proceeding to point C (described in conjunction with FIG. 9 herein).

Turning now to FIG. 9, a flowchart of a method 900 according to some embodiments is shown. In some embodiments, the method 900 may be associated with any of the systems 100, 400, 500, 1000, 1200 described herein. The method 900 may begin, for example, at 902 where an actuator control strategy (“s”) may be scored. In some embodiments, the method 900 may be repeated to score each of a plurality of known or available actuator control strategies. In some embodiments, the actuator control strategy (“s”) may be scored by scoring each load (“i”) of the load processing system, at 904. According to some embodiments, the processes performed at 902 and/or 904 may be similar to those practiced at 602, 702, 802 and/or 604, 704, 804 of the methods 600, 700, 800 described herein. In some embodiments, the method 900 may begin at either or both of points A or B and/or may initiate at point C, as a continuation of any of the methods 600, 700, 800 described herein.

The method 900 may include, for example, determining a score (“S”) for the strategy (“s”), at 960. The scores for all the loads (“Sᵢ”) may, for example, be summed at 960 to determine a score for the particular strategy being evaluated (“Sₛ”). In some embodiments, the scores for some or all loads (“Sᵢ”) may be summed at 960. According to some embodiments, other factors and/or functions may be included and/or performed in the determination of the strategy score (“Sₛ”) at 960. The method 900 may also be repeated for any or all of a plurality of strategies. In some embodiments, one or more strategies may be scored using different procedures as may be appropriate to effectively compare the various strategies. According to some embodiments, the scores for various strategies may then be utilized to select an appropriate strategy to apply to the load actuators (such as in the selection of strategies at 206).

In some embodiments, the various load scores (“Sᵢ”) may be received and/or determined at 960. According to some embodiments, the load scores (“Sᵢ”) may all be in the same format and/or represented in terms of the same metric. In other embodiments, one or more of the individual load scores (“Sᵢ”) may vary in format and/or terms of representation. For example, a servient load score (“Sᵢₛ”) may be represented in terms of a difference between desired and predicted velocities for the servient load, while other load scores (“Sᵢ”) may be represented in terms of a difference between desired and predicted translational locations for the other loads. In some embodiments, the load scores (“Sᵢ”) may be standardized to facilitate summation at 960. For example, the servient load score (“Sᵢₛ”) in terms of velocity differences may be multiplied by a time period and/or factor to convert the servient load score (“Sᵢₛ”) to be represented in terms of translational differences (e.g., ΔV*ΔT=Δx). According to some embodiments, any other standardization and/or transformation that is or becomes known or practicable may be applied to any number of individual load scores (“Sᵢ”) to arrive at the strategy score at 960.

Turning now to FIG. 10, a block diagram of a system 1000 for processing loads according to some embodiments is shown. The system may be associated with and/or carry out, for example, any of the methods 200, 600, 700, 800, 900, 1100 described herein. The system 1000 may, in some embodiments, include a load 1002 and/or a matrix of actuators 1004. The matrix of actuators 1004 may include various actuators such as the actuators 1004a-d overlapped by the load 1002. Either or both of the load 1002 and the matrix of actuators 1004 may be or be similar to those similarly-named components described in conjunction with FIG. 1, FIG. 4, and/or FIG. 5 herein. In some embodiments, other quantities and/or configurations of either or both of the load 1002 and the actuators 1004 may be used, and different types, layouts, quantities, and configurations of systems may be used, without deviating from the scope and/or purpose of some embodiments.

FIG. 10 shows a load 1002 that overlaps four conveyor-belt actuators 1004a-d. Each actuator 1004a-d is shown with a respective motion vector 1010a-d. The motion vectors 1010 may be or include, for example, the motion vectors as described in conjunction with any of the methods 200, 600, 700, 800, 900, 1100 described herein. For illustrative purposes, the motion vector 1010a associated with the lower-right actuator 1004a is also shown broken down into coordinate vector components 1012a, 1014a. The coordinate vector components 1012a, 1014a may be, for example, the x-axis 1006 and y-axis 1008 components 1012a, 1014a of the vector 1010a, respectively. Those skilled in the art will be familiar with methods and/or procedures for breaking a vector into such components. The other motion vectors 1010b-d may also be broken down into similar components (not shown).

Also shown in FIG. 10 are areas of overlap 1020a-d. The areas of overlap, as described previously herein, may represent the contact areas between the load 1002 and an actuator 1004a-d. For example, the area of overlap 1020a may be defined as the contacting surface area between the load 1002 and the lower-right actuator 1004a.

Referring now to FIG. 11 (and with continuing reference to FIG. 10 above), a method 1100 for determining the differences between expected load behaviors and desired load behaviors will be described. The method 1100 may begin, according to some embodiments, by identifying any actuators overlapped by a specific load, at 1102. Where the specific load is the load 1002 of system 1000, for example, the identified actuators may be the actuators 1004a-d. The motion vectors of the actuators 1010a-d may be, for example, motion vectors determined by a particular actuator control strategy (such as the strategies 300 described herein).

At 1104, the motion vector for each identified actuator may be weighted. In some embodiments, the vectors may be weighted by multiplying each vector by their respective areas of load overlap. For example, the motion vector 1010a for actuator 1010a may be weighted by multiplying the vector 1010a with the area of overlap 1020a. Similar calculations may be performed for each of the remaining overlapped actuators 1004b-d. According to some embodiments, other factors in addition to or in place of overlap area may be included in the weighting of the motion vectors 1010a-d.

In some embodiments, the method 1100 may continue at 1106 by determining an expected motion vector 1030 for the current load. For example, determining an expected motion vector 1030 may include summing the coordinate components (e.g., 1012a, 1014a) of the weighted vectors. The summed coordinate components may then, according to some embodiments, be converted back into a single resulting motion vector. The single resulting motion vector may be, for example, an expected motion vector 1030 for the current load. In some embodiments, other factors such as factors of safety and/or correction factors may be utilized in the calculation of the expected motion vector 1030.

At 1108, the difference between the expected motion vector 1030 and a desired motion vector for the load may be determined. In some embodiments, the coordinate components of the expected and desired vectors may be summed to produce a differential vector. In some embodiments, the differential vector may then be used to score and/or select strategies to be applied to a matrix of load actuators. According to some embodiments, the differential vector may be used to calculate and/or otherwise determine an expected deviation of the load from a desired position of the load. For example, the differential vector may be multiplied by a unit of time to determine an expected location deviation of the load at a particular time. The location deviation and/or deviant position of the load may be utilized, in some embodiments, to determine various factors such as the proximity to the critical line factor (“Cᵢ”) and/or the possibility of isolation factor (“Iᵢ”).

Referring now to FIG. 12, a block diagram of a system 1200 for mapping load motion vectors to actuator commands according to some embodiments is depicted for use in explanation, but not limitation, of described embodiments. In some embodiments, the system 1200 may be utilized, for example, to carry out any of the methods 200, 600, 700, 800, 900, 1100 described herein. According to some embodiments, different types, layouts, quantities, and configurations of systems may be used.

In some embodiments, the system 1200 may be or include a computer such as a computer server. The server 1200 may include one or more processors 1202, which may be any type or configuration of processor, microprocessor, and/or micro-engine that is or becomes known or available. In some embodiments, the server 1200 may also include one or more communication interfaces 1204, an output device 1206, an input device 1208, and/or a memory device 1210, all and/or any of which may be in communication with the processor 1202.

The communication interface 1204 may be or include any type and/or configuration of communication device that is or becomes known or available. In some embodiments, the communication device 1204 may allow the system 1200 (and/or the processor 1202) to communicate with, for example, a load processing system such as systems 100, 400, 500 and/or with a matrix of actuators such as the matrix 104, 404 described herein. In some embodiments, the processor 1202 may send signals to the matrix of actuators and/or any of the various individual actuators. The output device 1206 and the input device 1208 may be or include one or more conventional devices such as displays, printers, keyboards, a mouse, a trackball, etc. The devices 1206, 1208 may be utilized, for example, by an operator and/or system user to control a matrix of actuators and/or to map motion vectors to the matrix of actuators.

The memory device 1210 may be or include, according to some embodiments, one or more magnetic storage devices, such as hard disks, one or more optical storage devices, and/or solid state storage. The memory device 1210 may store, for example, applications, programs, procedures, and/or modules 1212, 1214, by which the server 1200 may map motion vectors to actuator control strategies in accordance with methods described herein. The strategy scoring module 1212, for example, may be a program for scoring actuator control strategies. In some embodiments, the strategy scoring module 1212 may process and/or implement, for example, the coloring and/or scoring at 204 and/or the methods 600, 700, 800, 900 as described herein. In some embodiments, the memory 1210 may also include a strategy coloring module (not shown) that may, for example, color loads to facilitate the scoring of strategies by the strategy scoring module 1212. The strategy selection module 1214 may, according to some embodiments, select one or more strategies to apply to a matrix of actuators. The strategy selection module 1214 may, for example, process and/or implement the selection at 206 as described in conjunction with FIG. 2 herein.

The several embodiments described herein are solely for the purpose of illustration. Persons skilled in the art will recognize from this description that other embodiments may be practiced with modifications and alterations limited only by the claims.

1. A method, comprising:
determining a desired relative behavior for a first load with respect to a second load, the loads being moveable by a plurality of load actuators.

2. The method of claim 1, wherein the plurality of load actuators are arranged in a substantially planar matrix.

3. The method of claim 1, further comprising:
selecting a strategy to control the plurality of load actuators based at least in part on a score associated with the strategy.

4. The method of claim 1, further comprising:
applying a strategy to control the plurality of load actuators.

5. The method of claim 1, further comprising:
determining a strategy to controlling the plurality of load actuators.

6. The method of claim 1, further comprising:
scoring a plurality of strategies for controlling the plurality of load actuators.

7. The method of claim 6, further comprising:
selecting a strategy from the plurality of scored strategies.

8. The method of claim 7, wherein the selected strategy is operable to control the plurality of load actuators such that the first load is moved in a manner at least similar to the desired relative behavior.

9. The method of claim 6, further comprising:
determining a desired behavior for the second load.

10. The method of claim 9, wherein the scoring the plurality of strategies includes:
determining, for each of the plurality of strategies, how the plurality of load actuators are expected to cause the loads to behave under the strategy.

11. The method of claim 10, wherein if, under a particular strategy, the expected behavior of the first load is determined prior to the determination of the expected behavior of the second load, the determining of the expected behaviors includes:
determining an expected behavior of the first load under the strategy, the expected behavior of the first load based at least in part on the desired relative behavior of the first load with respect to the desired behavior of the second load; and
determining an expected behavior of the second load under the strategy, the expected behavior of the second load based at least in part on the desired behavior of the second load.

12. The method of claim 10, wherein if, under a particular strategy, the expected behavior of the second load is determined prior to the determination of the expected behavior of the first load, the determining of the expected behaviors includes:
determining an expected behavior of the second load under the strategy, the expected behavior of the second load based at least in part on the desired behavior of the second load; and
determining an expected behavior of the first load under the strategy, the expected behavior of the first load based at least in part on the desired relative behavior of the first load with respect to the expected behavior of the second load.

13. The method of claim 10, wherein the scoring the plurality of strategies further includes:
determining, for each of the plurality of strategies, an expected deviation between the desired behaviors and the expected behaviors of the loads under the strategy.

14. The method of claim 13, wherein, for each of the plurality of strategies, the determination of the expected deviations includes:
determining, for the second load, a difference between the desired behavior of the second load and the expected behavior of the of the second load under the strategy;
determining, for the first load, a desired behavior of the first load with respect to the expected behavior of the second load, based at least in part on the desired relative behavior of the first load with respect to the second load; and
determining, for the first load, a difference between the determined desired behavior of the first load and the expected behavior of the first load under the strategy.

15. The method of claim 14, wherein the determining of the desired behavior of the first load with respect to the expected behavior of the second load includes:
determining a plurality of possible behaviors that satisfy the desired relative behavior of the first load with respect to the expected behavior of the second load.

16. The method of claim 15, wherein the determining of the difference between the determined desired behavior of the first load and the expected behavior of the first load under the strategy includes:
determining, for each of the plurality of possible behaviors, a difference between the possible behavior and the expected behavior of the first load under the strategy; and
selecting the smallest difference between the possible behaviors and the expected behavior of the first load under the strategy.

17. The method of claim 13, wherein the scoring the plurality of strategies further includes:
determining, for each of the plurality of strategies, a weighted deviation for each load under the strategy, at least by multiplying the expected deviation of each load by one or more weighting factors.

18. The method of claim 17, wherein at least one of the one or more weighting factors includes a priority factor associated with a priority of one of the loads.

19. The method of claim 18, wherein the priority factor associated with the priority of one of the loads is the product of (i) a priority assigned by a user, and at least one of (ii) a proximity of the load to a critical zone, or (iii) a factor associated with the isolation of the load from the other load.

20. The method of claim 17, wherein the scoring the plurality of strategies further includes:
summing, for each of the plurality of strategies, the weighted deviations of the loads.

21. The method of claim 20, wherein the weighted deviations of the loads are squared prior to the summing.

22. The method of claim 13, wherein the scoring the plurality of strategies further includes:
summing, for each of the plurality of strategies, the expected deviations of the loads.

23. The method of claim 22, wherein the expected deviations of the loads are squared prior to the summing.

24. The method of claim 13, wherein each of the expected deviations includes an expected deviation in translational motion and an expected deviation in rotational motion.

25. The method of claim 24, wherein each of the expected translational and rotational deviations are weighted by multiplying the deviations by a translational and a rotational weighting factor, respectively.

26. The method of claim 13, wherein the expected deviations include at least one of an expected velocity deviation or an expected location deviation.

27. The method of claim 26, wherein the scoring the plurality of strategies further includes:
standardizing, for each of the plurality of strategies, the expected deviations of the loads under the strategy.

28. The method of claim 27, wherein the standardizing includes:
converting any expected velocity deviations to location deviations by multiplying the expected velocity deviations by a time period.

29. The method of claim 28, wherein the scoring the plurality of strategies further includes:
summing, for each of the plurality of strategies, the standardized deviations of the loads.

30. The method of claim 10, wherein the expected behaviors includes at least one of an expected velocity, an expected direction, an expected rotation, or an expected location.

31. The method of claim 9, wherein the desired behavior of the second load includes at least one of a desired velocity, a desired direction, a desired rotation, or a desired location.

32. The method of claim 1, wherein the desired relative behavior includes at least one of a desired relative velocity, a desired relative direction, a desired relative rotation, or a desired relative location.

33. A method for scoring a strategy for controlling a plurality of load actuators, comprising:
predicting a first behavior of a first load that would result from implementation of the strategy, wherein the first behavior is based at least in part on a desired behavior of the first load;
predicting a second behavior of a second load that would result from implementation of the strategy, wherein the second behavior is based at least in part on a desired relative behavior of the second load with respect to the first load;
determining a first difference between the first behavior and the desired behavior of the first load;
determining a second difference between the second behavior and the desired relative behavior of the second load with respect to the first load; and
summing the first and second differences.

34. The method of claim 33, wherein the predicting of the second behavior includes:
determining a desired behavior for the second load by applying the desired relative behavior of the second load to the first behavior predicted for the first load; and
predicting the second behavior based at least in part on the determined desired behavior for the second load.

35. The method of claim 33, wherein the determining of the second difference includes:
determining a plurality of behaviors that, if applied to the second load, would satisfy the desired relative behavior of the second load with respect to the first behavior predicted for the first load;
determining, for each of the plurality of behaviors, a difference between the behavior and the second behavior predicted for the second load; and
identifying the smallest difference between the second behavior and any one of the plurality of behaviors.

36. The method of claim 33, wherein each of the behaviors includes at least one of a velocity, a direction, a rotation, or a translation.

37. The method of claim 36, wherein if one of the loads is determined to have a difference in terms of velocity and the other load is determined to have a difference in terms of translation, further comprising:
converting the difference in terms of velocity to a difference in terms of translation by multiplying the difference in terms of velocity by a time period.

38. The method of claim 33, wherein the differences include both translational and rotational differences, and wherein the summing includes:
multiplying the translational differences by a translational weighting factor;
multiplying the rotational differences by a rotational weighting factor; and
summing the products.

39. The method of claim 33, further comprising:
squaring the first and second differences.

40. The method of claim 33, further comprising:
weighting the first and second differences by multiplying the first difference by a first priority factor associated with the first load and multiplying the second difference by a second priority factor associated with the second load.

41. The method of claim 39, wherein each of the priority factors is the product of (i) a priority assigned by a user, and at least one of (ii) a proximity of the associated load to a critical zone, or (iii) a factor associated with the isolation of the associated load from the other load.

42. A system, comprising:
a processor; and
a storage medium having stored therein instructions that when executed by a machine result in:
determining a desired relative behavior for a first load with respect to a second load, the loads being moveable by a plurality of load actuators.

43. The system of claim 42, wherein the plurality of load actuators are arranged in a substantially planar matrix.

44. The system of claim 42, further comprising:
selecting a strategy for controlling the plurality of load actuators based at least in part on a score associated with the strategy.

45. An article of manufacture, comprising:
a storage medium having stored thereon programming code, comprising:
code to determine a desired relative behavior for a first load with respect to a second load, the loads being moveable by a plurality of load actuators.

46. The article of manufacture of claim 45, wherein the plurality of load actuators are arranged in a substantially planar matrix.

47. The article of manufacture of claim 45, wherein the programming code further comprises:
code to select a strategy for controlling the plurality of load actuators based at least in part on a score associated with the strategy.

48. A system, comprising:
means for scoring a plurality of strategies for controlling a plurality of load actuators, wherein the scoring is based at least in part on a relative behavior for a first load with respect to a second load; and
means for selecting a strategy from the plurality of strategies based at least in part on the score associated with the strategy.
